(19) United States
(12) Patent Application Publication
(10) Pub. No.: US 2025/0022440 A1
(43) Pub. Date: Jan. 16, 2025

(54) SEQUENTIAL FLEXIBLE DISPLAY SHAPE RESOLUTION

(71) Applicant: QUALCOMM Incorporated, San Diego, CA (US)

(72) Inventors: Nan ZHANG, Beijing (CN); Yongjun XU, Beijing (CN)

(21) Appl. No.: 18/714,553

(22) PCT Filed: Dec. 15, 2022
(86) PCT No.: PCT/CN2022/139227

§ 371 Date: May 29, 2024

(30) Foreign Application Priority Data
Jan. 28, 2022 (WO) PCT/CN2022/074517

(51) Int. Cl. G09G 5/391

(52) U.S. Cl. CPC G09G 5/391; G09G 2340/0407; G09G 2360/18

(57) ABSTRACT

Aspects presented herein relate to methods and devices for display processing including an apparatus, e.g., a DPU. The apparatus may transmit, to a display panel, a first frame including a border filling region with a plurality of first pixels, where each of the plurality of first pixels includes a border filling color. The apparatus may also configure at least one second frame including a valid pixel region with a plurality of second pixels, where the at least one second frame includes second content data and a second pixel resolution. The apparatus may also transmit, to the display panel, the at least one second frame including the valid pixel region with the plurality of second pixels. Further, the apparatus may obtain an indication of a resolution update for the at least one second frame. The apparatus may also adjust the valid pixel region of the at least one second frame.

### CROSS REFERENCE TO RELATED APPLICATION(S)

This application claims the benefit of and priority to International Application No. PCT/CN2022/074517, entitled “SEQUENTIAL FLEXIBLE DISPLAY SHAPE RESOLUTION” and filed on Jan. 28, 2022, which is expressly incorporated by reference herein in its entirety.

### TECHNICAL FIELD

The present disclosure relates generally to processing systems and, more particularly, to one or more techniques for display processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A GPU of a device may be configured to perform the processes in a graphics processing pipeline. Further, a display processor or display processing unit (DPU) may be configured to perform the processes of display processing. However, with the advent of wireless communication and smaller, handheld devices, there has developed an increased need for improved graphics or display processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a display processing unit (DPU) or any apparatus that may perform display processing. The apparatus may transmit, to a display panel, a first frame including a border filling region with a plurality of first pixels, where each of the plurality of first pixels includes a border filling color. The apparatus may also configure at least one second frame including a valid pixel region with a plurality of second pixels, where the at least one second frame includes second content data and a second pixel resolution. The apparatus may also transmit, to the display panel, the at least one second frame including the valid pixel region with the plurality of second pixels. Further, the apparatus may obtain an indication of a resolution update for the at least one second frame. The apparatus may also adjust the valid pixel region of the at least one second frame based on the indication of the resolution update. The apparatus may also configure, after adjusting the valid pixel region of the at least one second frame, an updated pixel resolution of the plurality of second pixels of the at least one second frame based on the indication of the resolution update. Moreover, the apparatus may retransmit, to the display panel, the first frame including the border filling region with the plurality of first pixels. The apparatus may also transmit, to the display panel, the at least one second frame including the adjusted valid pixel region and the updated pixel resolution of the plurality of second pixels.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system.

FIG. 2 illustrates an example graphics processing unit (GPU).

FIG. 3 illustrates an example display framework including a display processor and a display.

FIG. 4 is a diagram illustrating an example mask layer for display processing.

FIG. 5 is a diagram illustrating an example layer composition scheme for display processing.

FIG. 6 is a diagram illustrating an example display device for display processing.

FIG. 7 is a diagram illustrating an example border filling process for display processing.

FIG. 8 is a flowchart of an example method of display processing.

FIG. 9A is a diagram illustrating an example border filling process for display processing.

FIG. 9B is a diagram illustrating an example border filling process for display processing.

FIG. 10 is a communication flow diagram illustrating example communications between an application, a display processing unit (DPU), and a display.

FIG. 11 is a flowchart of an example method of display processing.

FIG. 12 is a flowchart of an example method of display processing.

### DETAILED DESCRIPTION

Certain types of displays (e.g., flexible displays, dual displays, triple displays, round displays, and other novel display panel identifier (ID) designs) are becoming increasingly popular for display processing techniques. Also, certain types of displays (e.g., flexible displays, dual displays, triple displays, round displays) and devices may utilize display border filling to match a mechanical design or ID design. In some aspects of display processing, border filling for a frame (e.g., display shape border filling) may be performed in certain locations within a display processing unit (DPU) (e.g., a hardware (HW) mixer or a DPU hardware mixer). This practice of performing border filling in certain DPU locations may conflict with some display post-processing functionalities. For instance, before the frame processing begins, the border filling lines for the frame may already be added. This type of border filling procedure may have a reduced accuracy due to the conflict with other display post-processing functionalities. In some aspects, blocks and processing units in a border filling pipeline at a DPU that are after the hardware mixer (i.e., blocks for frame data generation) may process additional border filling lines. This may cause the border filling lines to be erroneously processed. Additionally, other types of display processing units and display processing functions may suffer based on this erroneous border filling processing. Some types of displays, such as dual flexible display projects/devices, may benefit from a more accurate solution to the aforementioned border filling function problem. This problem may also be applicable to flexible IDs in display processing and flexible display devices. Aspects of the present disclosure may utilize a border filling function that produces accurate border filling for display processing. Aspects of the present disclosure may also utilize display processing features for accurate border filling procedures and border filling without any limitations. For instance, aspects presented herein may utilize DPUs and display processing features/functionalities that are related to accurate border filling functions and border filling functions without any limitations. In some instances, aspects presented herein may utilize a hybrid sequential partial frame update for border filling configurations of display panels that includes a flexible resolution and/or a flexible shape. Further, aspects presented herein may utilize border filling configurations that utilize a configurable resolution adjustment and/or a configurable size.

Aspects of the present disclosure may include a number of benefits or advantages. For instance, aspects of the present disclosure may provide a display border filling solution with full display processing features, as well as functions that may concurrently run with other border filling solutions. Aspects presented herein may allow for a flexible display border fill and/or a flexible resolution with full display processing features and functions. These flexible or configurable border filling configurations may run simultaneously for display devices with other border filling configurations. Aspects presented herein may also be utilized for flexible extendable displays with flexible resolutions. Further, aspects presented herein may allow DPUs to reduce the amount of display serial interface (DSI) bandwidth by avoiding reductant pixel transmissions. Moreover, aspects presented herein may allow DPUs to reduce the amount of power utilized by avoiding reductant pixel transmissions. For example, aspects presented herein may allow DPUs to solely transmit valid pixels to a display, such that DPUs may avoid the unnecessary transmission of invalid pixels.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

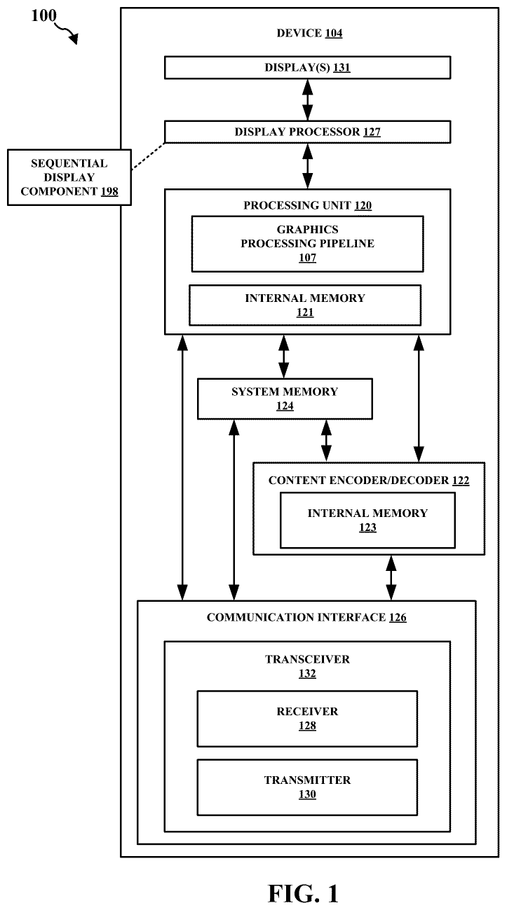

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the display processor 127 may include a sequential display component 198 configured to transmit, to a display panel, a first frame including a border filling region with a plurality of first pixels, where each of the plurality of first pixels includes a border filling color. The sequential display component 198 may also be configured to configure at least one second frame including a valid pixel region with a plurality of second pixels, where the at least one second frame includes second content data and a second pixel resolution. The sequential display component 198 may also be configured to transmit, to the display panel, the at least one second frame including the valid pixel region with the plurality of second pixels. The sequential display component 198 may also be configured to obtain an indication of a resolution update for the at least one second frame. The sequential display component 198 may also be configured to adjust the valid pixel region of the at least one second frame based on the indication of the resolution update. The sequential display component 198 may also be configured to configure, after adjusting the valid pixel region of the at least one second frame, an updated pixel resolution of the plurality of second pixels of the at least one second frame based on the indication of the resolution update. The sequential display component 198 may also be configured to retransmit, to the display panel, the first frame including the border filling region with the plurality of first pixels. The sequential display component 198 may also be configured to transmit, to the display panel, the at least one second frame including the adjusted valid pixel region and the updated pixel resolution of the plurality of second pixels. Although the following description may be focused on display processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

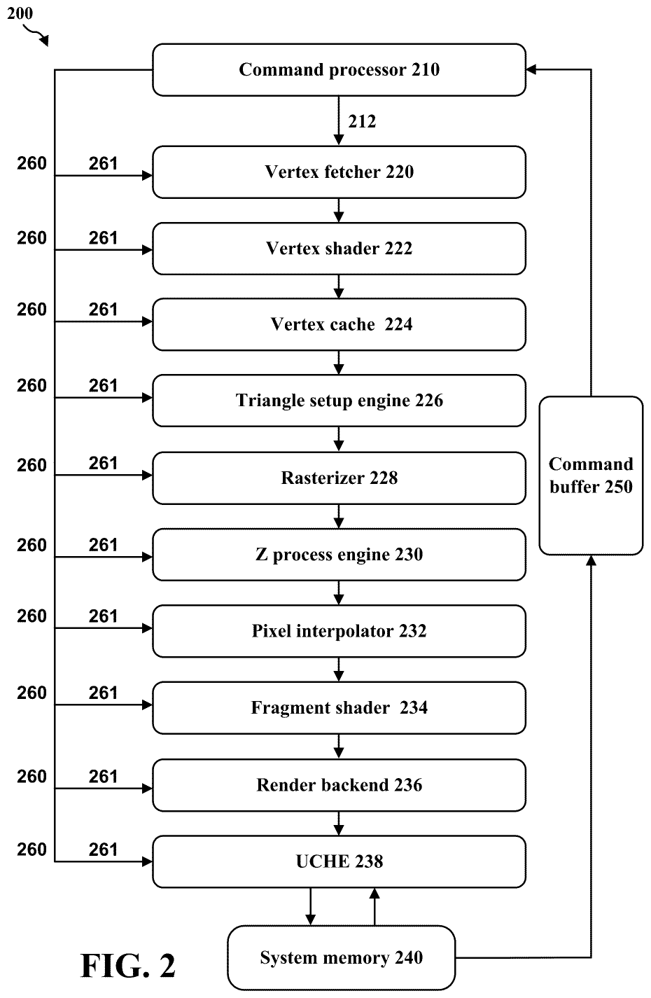

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUS according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

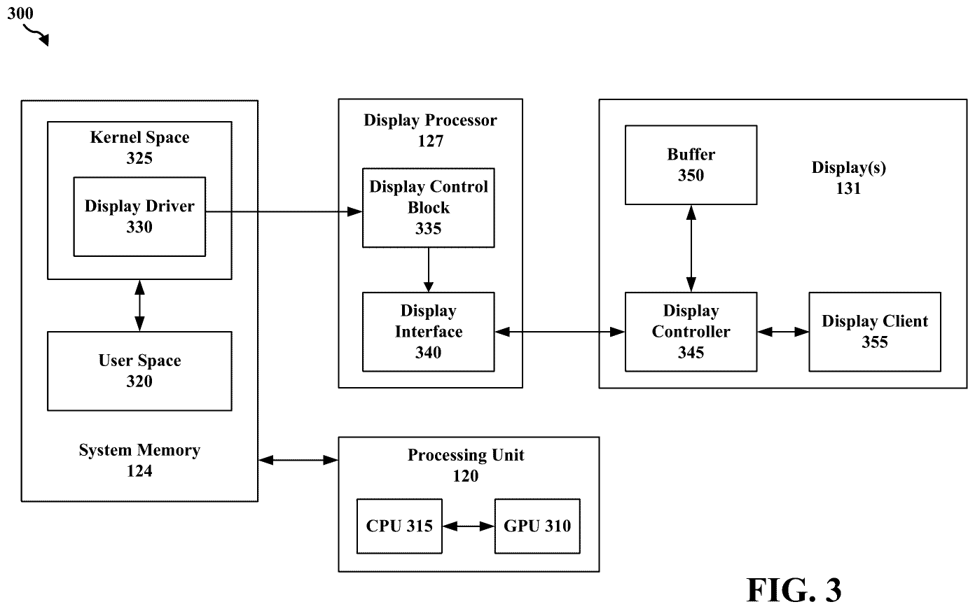

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120. The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

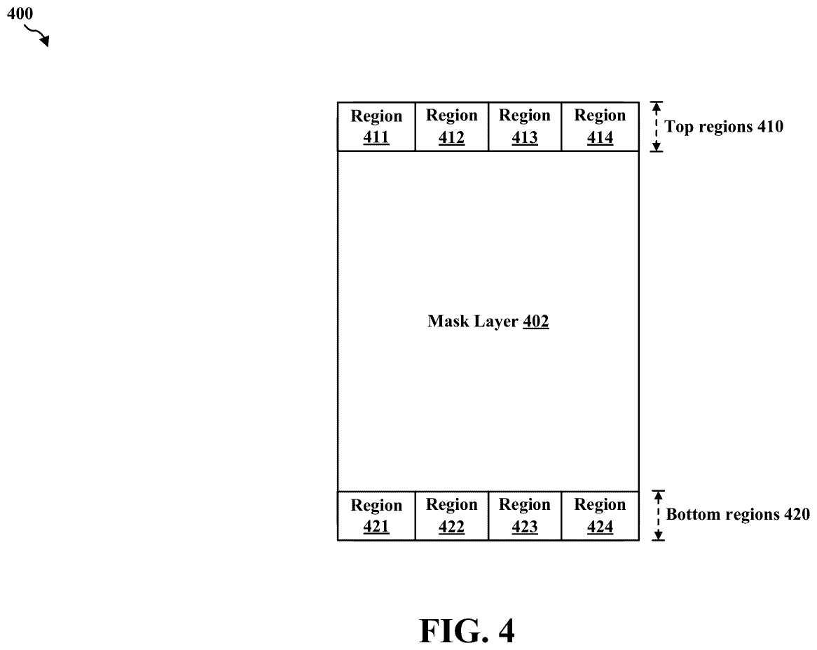

FIG. 4 is a diagram 400 illustrating an example mask layer for display processing. More specifically, diagram 400 depicts one type of mask layer that may represent portions of a display panel. As shown in FIG. 4, diagram 400 includes mask layer 402 including top regions 410 and bottom regions 420. Top regions 410 include region 411, region 412, region 413, and region 414, and bottom regions 420 include region 421, region 422, region 423, and region 424. As depicted in FIG. 4, mask layer 402 may represent the different regions that are displayed on a display panel.

Some types of displays may use a certain type of mask layer (e.g., a shape mask layer) to reshape a display frame. For instance, a mask layer may reshape the display frame to provide more optimized visual shapes at the display panel (e.g., improved round corners, improved circular shape, improved rectangular shape, etc.). These types of mask layers (e.g., shape mask layers) may be processed by software (e.g., graphics processing unit (GPU) software or central processing unit (CPU) software) or by hardware (e.g., display processing unit (DPU) hardware). Also, these mask layers may be processed by other specific types of hardware logic modules (e.g., modules in a display driver integrated circuit (DDIC) or bridge chips). In some aspects, these types of mask layers (e.g., shape mask layers) may be based on certain unit, such as a pixel. That is, the shape generation basis unit of the shape mask layers may be a single pixel.

Some aspects of display processing may utilize frame buffers to cache or store a composition output of a GPU. For instance, display layers may be cached or stored in a frame buffer after composition at a GPU. In some aspects, a composition hardware (HW) or software (SW) stack may use a frame buffer target to cache a composition output (e.g., a GPU composition output or a CPU composition output). The cached composition output may then be sent to another processor (e.g., a DPU) as an input layer. The frame buffer may have a number of different color formats, such as a red (R) green (G) blue (B) alpha (A) (RGBA) format (e.g., RGBA8888 format). Also, the frame buffer may be a certain size, (e.g., a 32-bit triple buffer). For example, at the beginning of a display/graphics subsystem design, a frame buffer may be created as an RGBA8888 format and a 32-bit triple buffer. In some instances, if the frame layers do not use a certain composition (e.g., a GPU or client composition), the frame buffers may be ignored. Also, the layers (e.g., frame layers or display layers associated with display processing) may be directly fetched and composed. For instance, a DPU or hardware composer may directly fetch the layers and then compose the layers.

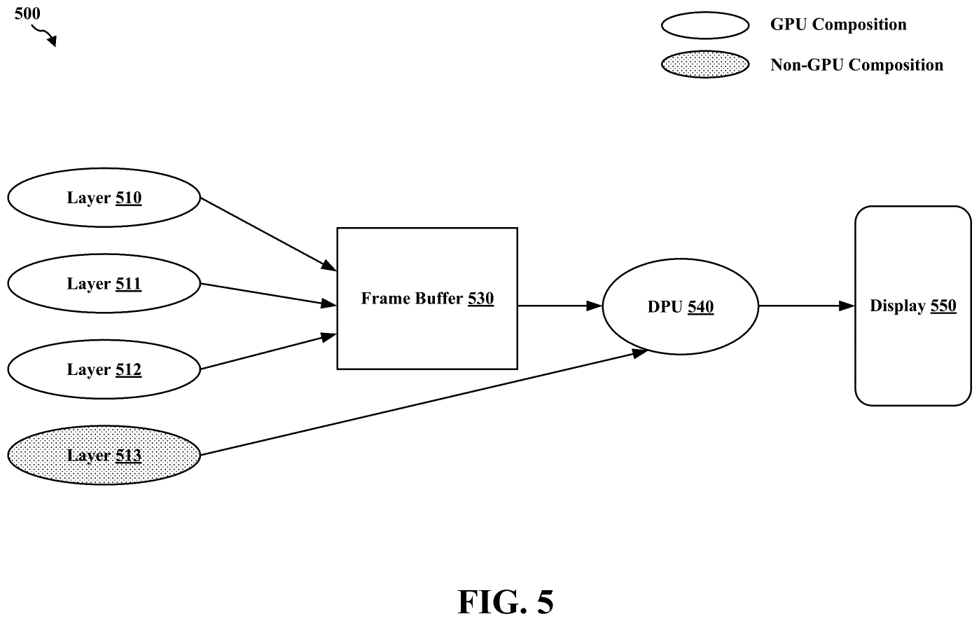

FIG. 5 is a diagram 500 illustrating an example of a layer composition scheme for display processing. More specifically, diagram 500 depicts a layer composition of display layers where certain layers (e.g., layers of a certain composition) are cached in a frame buffer, and some layers are directly fetched and composed by a DPU. As shown in FIG. 5, diagram 500 includes layer 510, layer 511, layer 512, layer 513, frame buffer 530 (e.g., an RGBA8888 format frame buffer), DPU 540, and display 550. FIG. 5 depicts that layers composed at a GPU (i.e., layers associated with GPU composition) may be cached or stored in a frame buffer. For example, layer 510, layer 511, and layer 512 may be composed at a GPU and then cached/stored at frame buffer 530. Alternatively, layers that are not composed at a GPU (i.e., layers associated with non-GPU composition) may be directly fetched and composed at a DPU. For instance, layer 513 may be directly fetched and composed at DPU 540. That is, layer 510, layer 511, and layer 512 may be a certain type of composition (e.g., GPU composition), while layer 513 may be another type of composition (non-GPU composition). After being cached/stored in frame buffer 530, the layer 510, layer 511, and layer 512 may be sent to DPU 540. Further, after processing at DPU 540, the layers 510-513 may be sent to display 550.

Some types of display processing devices (e.g., mobile devices, computers, TVs, or other consumer devices) may utilize complex multiple content layouts in a single display processing layer or multiple display processing layers. That is, for graphics or display stacks in operating systems of the devices, there may be a single display processing layer (i.e., display layer or layer that is associated with display processing) or multiple display processing layers. For instance, there may be at least one display layer that may be associated with a screen or frame for a display processing device, such that the display panel at the device may be divided amongst the display layers. Additionally, for content or end users, there may be multiple content entities in the display processing layer. This may be due to operating system limitations and/or application rendering/resource management limitations. Further, some types of applications may choose to render in using a single display processing layer. Color processing capability on a per-region basis (i.e., for each region of interest (ROI) in a layer) may be utilized with certain types of display processing unit (DPU) architecture.

Different types of DPU image processing (e.g., DPU per-layer flexible image processing) may be utilized by current mobile consumer electronics devices. Based on the content of different layers, providing accurate per-layer image processing may be important to the perception of an end user. There may be a number of different types of per-layer image processing, such as video high dynamic range (HDR) layer tone mapping and processing and/or video standard dynamic range (SDR) layer visual contrast boosting. Types of per-layer image processing may also include proper tone mapping for photo image layers, game layer color processing and flexible visual control options provided to end users, flexible visual control options for video layers provided to end users, and flexible visual control options for texts/user interface (UI) layers provided to end users.

Certain types of displays (e.g., flexible displays, dual displays, triple displays, round displays, and other novel display panel identifier (ID) designs) are becoming increasingly popular for display processing techniques. Also, certain types of displays (e.g., flexible displays, dual displays, triple displays, round displays) and devices may utilize display border filling to match a mechanical design or ID design. In some aspects of display processing, border filling for a frame (e.g., display shape border filling) may be performed in certain locations within a display processing unit (DPU) (e.g., a hardware (HW) mixer or a DPU hardware mixer). This practice of performing border filling in certain DPU locations may conflict with some display post-processing functionalities. For instance, before the frame processing begins, the border filling lines for the frame may already be added. This type of border filling procedure may have a reduced accuracy due to the conflict with other display post-processing functionalities.

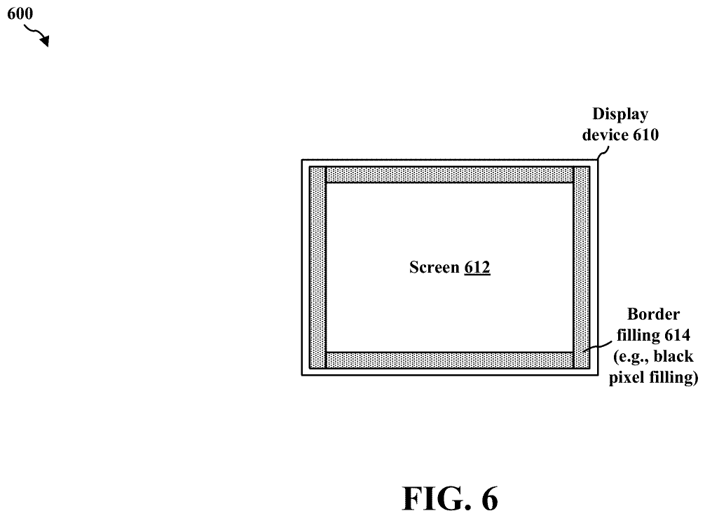

FIG. 6 is a diagram 600 illustrating an example display device for display processing. As shown in FIG. 6, diagram 600 includes display device 610 including screen 612 (e.g., a screen or frame) and border filling 614. The screen 612 may be in the center portion of the display device 610 and take up a majority of the display device 610. The border filling 614 may extend along the outer portion, border, or perimeter of the display device 610. In some aspects, the border filling 614 may extend up to the edge of the display device 610. In other aspects, there may be a small space between the edge of the border filling 614 and the edge of the display device 610 (as shown in FIG. 6). The border filling 614 may include certain types of pixel filling (e.g., black pixel filling). The border filling 614 may include any suitable color for the pixel filling (e.g., black, gray, brown, blue, green, red, etc.). The border filling 614 may take up any amount of space around the exterior or perimeter of the display device. For example, the border filling 614 may include a certain number of lines and/or columns of the display device 610 (e.g., 20 lines and/or 12 columns of black pixel filling).

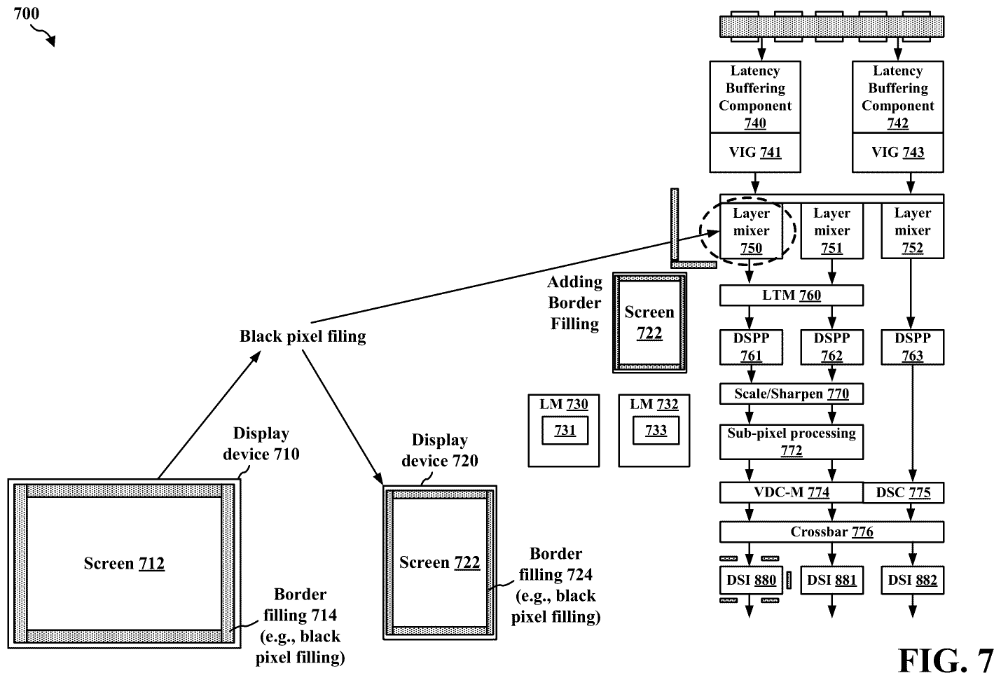

FIG. 7 is a diagram 700 illustrating an example border filling process for display processing. As shown in FIG. 7, diagram 700 includes display device 710 including screen 712 (e.g., a screen or frame) and border filling 714, as well as display device 720 including screen 722 (e.g., a screen or frame) and border filling 724. Diagram 700 also includes a number of layer mixers (LMs) (e.g., LM 730 including area 731 and LM 732 including area 733). Additionally, diagram 700 includes a number of display hardware components, such as latency buffering components (e.g., latency buffering component 740 and latency buffering component 742), video and graphics (VIG) components (e.g., VIG 741 and VIG 743), and other layer mixers (e.g., LM 750, LM 751, and LM 752). Diagram 700 also includes a local tone mapping (LTM) component (e.g., LTM 760) and several destination surface post processing (DSPP) components (e.g., DSPP 761, DSPP 762, and DSPP 763). Further, diagram 700 includes scale/sharpen component 770, sub-pixel processing component 772 (including a round corner (RC) component, a sub-pixel renderer (SPR), and a Demura component). Diagram 700 also includes video compression engine (VDC-M) (e.g., VDC-M 774) and display stream compression (DSC) component (e.g., DSC 775). Also, diagram 700 includes crossbar 776 and several digital serial interfaces (DSIs) (e.g., DSI 880, DSI 881, and DSI 882).

As shown in FIG. 7, screen 712 and screen 722 may be in the center portion of the display device 710 and display device 720, respectively. The border filling 714 may extend along the outer portion, border, or perimeter of the display device 710, and border filling 724 may extend along the outer portion, border, or perimeter of the display device 720. In some aspects, the border filling 714 and border filling 724 may extend up to the edge of the display device 710 and display device 720, respectively. In other aspects, there may be a small space between the edge of the border filling 714 and the edge of the display device 710, as well as between the edge of the border filling 724 and the edge of the display device 720 (as shown in FIG. 7). The border filling 714 and border filling 724 may include certain types of pixel filling (e.g., black pixel filling). The border filling 714 and border filling 724 may include any suitable color for the pixel filling (e.g., black, gray, brown, blue, green, red, etc.). The border filling 714 and border filling 724 may take up any amount of space around the exterior or perimeter of the display device. For example, the border filling 714 and border filling 724 may include a certain number of lines and/or columns of the display device 710 and display device 720, respectively (e.g., 20 lines and/or 12 columns of black pixel filling). As further shown in FIG. 7, a number of lines (e.g., 12 lines) of black pixel filling may be added to a screen or frame (e.g., screen 712 and screen 722) during a border filling process. For example, this process may be performed by a layer mixer (e.g., layer mixer 750) or hardware mixer at a DPU (e.g., in a border filling pipeline at a DPU).

In some aspects, as depicted in FIG. 7, blocks and processing units in a border filling pipeline at a DPU (e.g., the blocks and processing units in FIG. 7) that are after the hardware mixer (i.e., blocks for frame data generation) may process additional border filling lines. This may cause the border filling lines to be inaccurately or erroneously processed for the screen or frame. Additionally, other types of display processing units and display processing functions may suffer based on this inaccurate or erroneous border filling processing. Some types of displays, such as dual flexible display projects/devices, may benefit from a more accurate solution to the aforementioned border filling function problem during border filling processes. This problem may also be applicable to other types of display components, such as flexible IDs in display processing and flexible display devices. Accordingly, it may be beneficial to utilize a border filling function that produces an accurate border fill for display processing. Further, it may be beneficial to utilize DPUs and/or display processing features/functionalities that are related to accurate border filling functions and border filling functions without any limitations.

Aspects of the present disclosure may utilize a border filling function that produces accurate border filling for display processing. Aspects of the present disclosure may also utilize display processing features for accurate border filling procedures and border filling without any limitations. For instance, aspects presented herein may utilize DPUs and display processing features/functionalities that are related to accurate border filling functions and border filling functions without any limitations (e.g., limitations with respect to certain display devices). In some instances, aspects presented herein may utilize a hybrid sequential partial frame update for border filling configurations of display panels that includes a flexible resolution and/or a flexible shape. By utilizing border filling configurations with a flexible resolution and/or a flexible shape, aspects presented herein may be applicable to border filling for a wide array of display devices. Further, aspects presented herein may utilize border filling configurations that utilize a configurable resolution adjustment and/or a configurable size.

In some instances, aspects presented herein may allow DPUs to use border filling configurations that include a partial update and/or full frame filling color. This may result in DPUs avoiding utilizing border filling configurations that utilize a high amount of processor capabilities and/or a high amount of power (e.g., border filling configurations that are within a layer mixer (LM) and a composition stage). Further, aspects presented herein may allow DPUs to align a resolution for an application or operating system (OS) with a resolution for partial frame update regions. Moreover, aspects presented herein may allow for a seamless resolution adjustment for flexible displays and/or flexible identifiers (IDs) associated with display processing. For instance, aspects presented herein may utilize a partial frame update for a seamless frame update, as well as update certain resolutions (e.g., device OS resolutions) and frame contents. Also, for certain types of transmissions (e.g., display serial interface (DSI) link transmissions), aspects of the present disclosure may allow DPUs to solely transmit or communicate valid pixel values. By doing so, DPUs may avoid the unnecessary transmission or communication of invalid pixels, which may reduce the amount of power and bandwidth utilized at the DPUs.

Additionally, aspects of the present disclosure may provide a display border filling solution with a complete set of display processing features, as well as functions that may concurrently run with other border filling solutions. Aspects presented herein may also allow for a flexible display border fill and/or a flexible resolution with a complete set of display processing features and functions. In some aspects, these flexible or configurable border filling configurations may run simultaneously for display devices with other border filling configurations. Aspects presented herein may also be utilized for flexible extendable displays with flexible resolutions. Also, aspects presented herein may allow DPUs to reduce the amount of DSI bandwidth by avoiding reductant pixel transmissions. Further, aspects presented herein may allow DPUs to reduce the amount of power utilized by avoiding reductant pixel transmissions. For example, aspects presented herein may allow DPUs to solely transmit valid pixels to a display panel, such that DPUs may avoid the reductant transmission of invalid pixels.

In some aspects, during a panel initiation procedure, aspects presented herein may allow DPUs to send first frame data with a border filling color. For example, DPUs may send first frame data with a border filling that is black (e.g., pure black 0) or any appropriate border filling color. In some instances, the first frame data may just include the border filling color, and not include any other data. The resolution may be a certain type of resolution (e.g., display panel native 1080×2400 resolution), where a number of lines are used for border filling (e.g., 90 widths and 300 lines are used for border filling). In some aspects, during run-time, aspects presented herein may allow DPUs to keep all display processing procedures intact (e.g., display composition or mixing procedures), as well as allow DPUs to configure display frame resolutions to valid pixel regions. As such, a DPU and/or a display processing stack may save on processing and power by not handling border filling lines. Aspects of the present disclosure may configure resolutions for DPUs/mixers/processing blocks to a certain resolution (e.g., 1010×2100), which may correspond to valid pixel regions. Also, aspects of the present disclosure may configure all operating systems (OS) and application resolutions for rendering and user interface (UI) design to a particular resolution (e.g., 1010×2100).

In some instances, during run-time, all frames that are transmitted may include a display serial interface (DSI) valid region that is associated with a partial frame update (e.g., a resolution of 1010×2100). This sequential partial update may be performed by sending the rectangle coordinates (e.g., a resolution of 1010×2100) to the display panel. DPUs may also continue to utilize a valid region refresh of a same resolution (e.g., a resolution of 1010×2100). For example, a DPU may send the rectangle coordinates of a certain resolution once to a display panel, and then continue to utilize a valid region refresh of a same resolution. Alternatively, aspects presented herein may send the rectangle coordinates once per-frame (e.g., a resolution of 1010×2100) to the display panel.

Additionally, in some instances, aspects presented herein may allow DPUs to adjust the display border filling shapes and/or valid display regions during run-time. For instance, DPUs may adjust the display border filling shapes and/or valid display regions during run-time to match certain device adjustments (e.g., adjustments for IDs, display scenarios, device power, always-on displays (AODs), etc.). Further, each time a display border filling shape and/or valid display region changes, a number of frames including black pixels (e.g., one frame including black pixels with a panel native resolution) or other filling color pixels may be sent to the display panel. Based on this, the DPU, the operating system, and/or the entire device may be configured to the updated valid pixel region resolution. Also, updated rectangle coordinates and updated valid pixel region resolutions may be sent to the display panel.

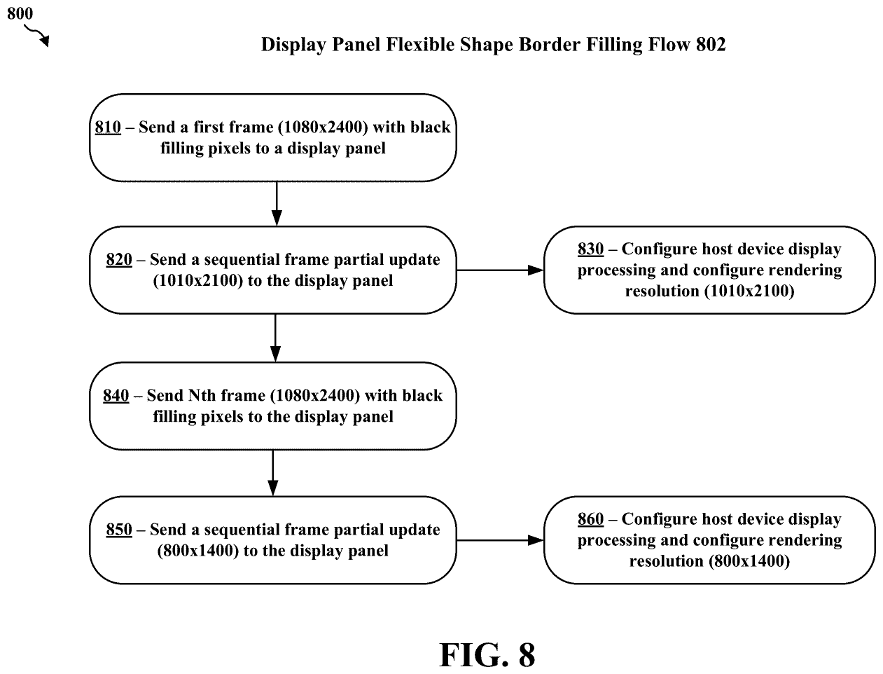

FIG. 8 is a flowchart 800 of an example method of display processing. As shown in FIG. 8, flowchart 800 depicts a display panel flexible shape border filling flow 802 for a DPU. At step 810, the DPU may send, to a display panel, a first frame (e.g., a frame with a 1080×2400 resolution) with black filling pixels. At step 820, the DPU may send, to the display panel, a sequential frame partial update (PU) (e.g., an update of 1010×2100 resolution). At step 830, the DPU may configure the display processing for a host device and/or configure a rendering resolution (e.g., for the host device) to a certain resolution (e.g., 1010×2100 resolution). At step 840, the DPU may send, to the display panel, an Nth frame (e.g., a frame with 1080×2400 resolution) with black filling pixels. At step 850, the DPU may send, to the display panel, a sequential frame partial update (PU) (e.g., an update of 800×1400 resolution). Moreover, at step 860, the DPU may configure the display processing for the host device and/or configure a rendering resolution (e.g., for the host device) to a certain resolution (e.g., 800×1400 resolution).

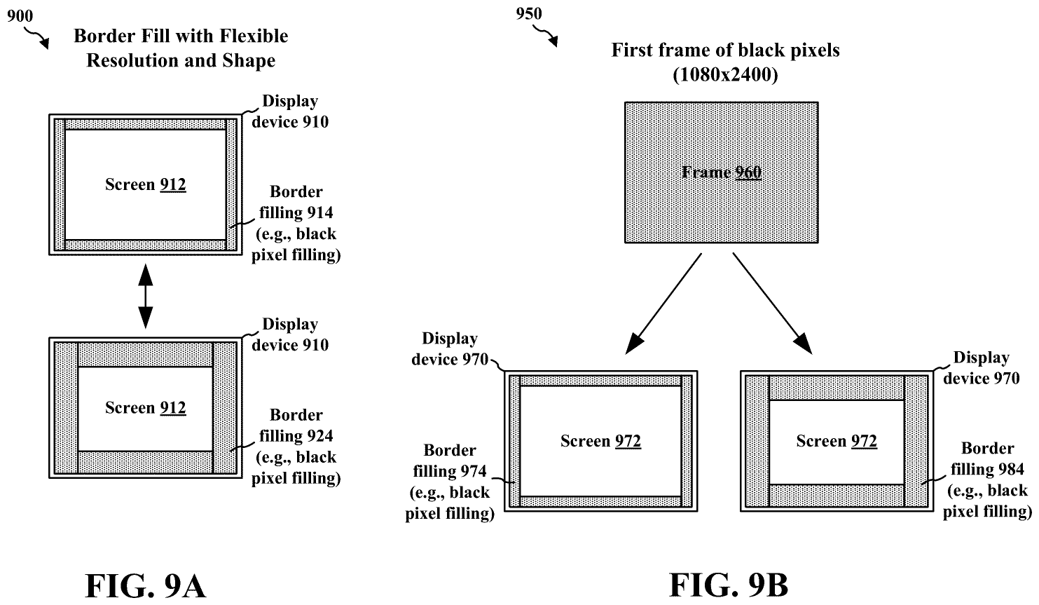

FIG. 9A is a diagram 900 illustrating an example border filling process for display processing. As shown in FIG. 9A, diagram 900 depicts a border fill with a flexible resolution and/or a flexible shape. FIG. 9A shows display device 910 including screen 912 (e.g., a screen or frame) and border filling 914. Also, FIG. 9A shows display device 910 including screen 912 (e.g., a screen or frame) and border filling 924. As depicted in FIG. 9A, display device 910 may be configured to use one type of border filling (e.g., border filling 914) or another type of border filling (e.g., border filling 924). That is, display device 910 may utilize a border with one type of resolution and shape (e.g., border filling 914), as well as a border with another type of resolution and shape (e.g., border filling 924). Indeed, DPUs may configure display devices (e.g., display device 910) to use a flexible amount of border filling, whether in terms of resolution and/or shape. Accordingly, aspects presented herein may allow DPUs to flexibly fill the borders around the exterior or perimeter of the display panel with black pixels including a configurable resolution and/or a configurable shape.

FIG. 9B is a diagram 950 illustrating an example border filling process for display processing. As shown in FIG. 9B, diagram 950 depicts a first frame 960 of black pixels (e.g., with resolution 1080×2400) that is utilized for border filling around a screen or frame of a display device. Similar to FIG. 9A, FIG. 9B depicts a border fill with a flexible resolution and/or a flexible shape. FIG. 9B shows display device 970 including screen 972 (e.g., a screen or frame) and border filling 974. Also, FIG. 9B shows display device 970 including screen 972 (e.g., a screen or frame) and border filling 984. As depicted in FIG. 9B, display device 970 may be configured to use one type of border filling (e.g., border filling 974) or another type of border filling (e.g., border filling 984). For instance, display device 970 may utilize a border with one type of resolution and shape (e.g., border filling 974), as well as a border with another type of resolution and shape (e.g., border filling 984). As such, DPUs may configure display devices (e.g., display device 970) to use a flexible amount of border filling, whether in terms of resolution and/or shape. For example, the border filling 974 may be a certain width and an include a certain amount of lines (e.g., a width equal to 90 and 300 lines), while the border filling 984 may be another width and an include another amount of lines. Further, this amount of black pixel filling in display device 970 may correspond to a valid pixel region of a certain resolution (e.g., a resolution of 1010×2100). FIG. 9B depicts that a DPU may transmit, to a display panel, a first frame (e.g., first frame 960) including a border filling region with a plurality of first pixels. Also, FIG. 9B depicts that a DPU may configure and transmit, to the display panel, at least one second frame (e.g., a frame for screen 972) including a valid pixel region with a plurality of second pixels.

In some aspects, aspects presented herein may allow DPUs to use border filling configurations that include a partial update and full frame filling color. This may allow DPUs to avoid utilizing border filling configurations that utilize extra processor capabilities and/or power (e.g., border filling configurations are within a layer mixer (LM) and a composition stage). Also, aspects presented herein may allow DPUs to directly align a resolution for an application or operating system (OS) with a resolution for partial frame update regions. Further, aspects presented herein may allow for a seamless resolution adjustment for flexible displays and/or flexible identifiers (IDs). For instance, aspects presented herein may directly use a partial frame update for a seamless frame update, as well as update certain resolutions (e.g., device OS resolutions) and frame contents. Additionally, for certain types of transmissions (e.g., display serial interface (DSI) link transmissions), aspects of the present disclosure may allow DPUs to solely transmit valid pixel values. By doing so, DPUs may avoid the unnecessary transmission of invalid pixels, which may reduce the amount of power and bandwidth utilized at the DPUs.

Aspects of the present disclosure may include a number of benefits or advantages. For instance, aspects of the present disclosure may provide a display border filling solution with full display processing features, as well as functions that may concurrently run with other border filling solutions. Aspects presented herein may allow for a flexible display border fill and/or a flexible resolution with full display processing features and functions. These flexible or configurable border filling configurations may run simultaneously for display devices with other border filling configurations. Aspects presented herein may also be utilized for flexible extendable displays with flexible resolutions. Further, aspects presented herein may allow DPUs to reduce the amount of DSI bandwidth by avoiding reductant pixel transmissions. Moreover, aspects presented herein may allow DPUs to reduce the amount of power utilized by avoiding reductant pixel transmissions. For example, aspects presented herein may allow DPUs to solely transmit valid pixels to a display, such that DPUs may avoid the unnecessary transmission of invalid pixels.

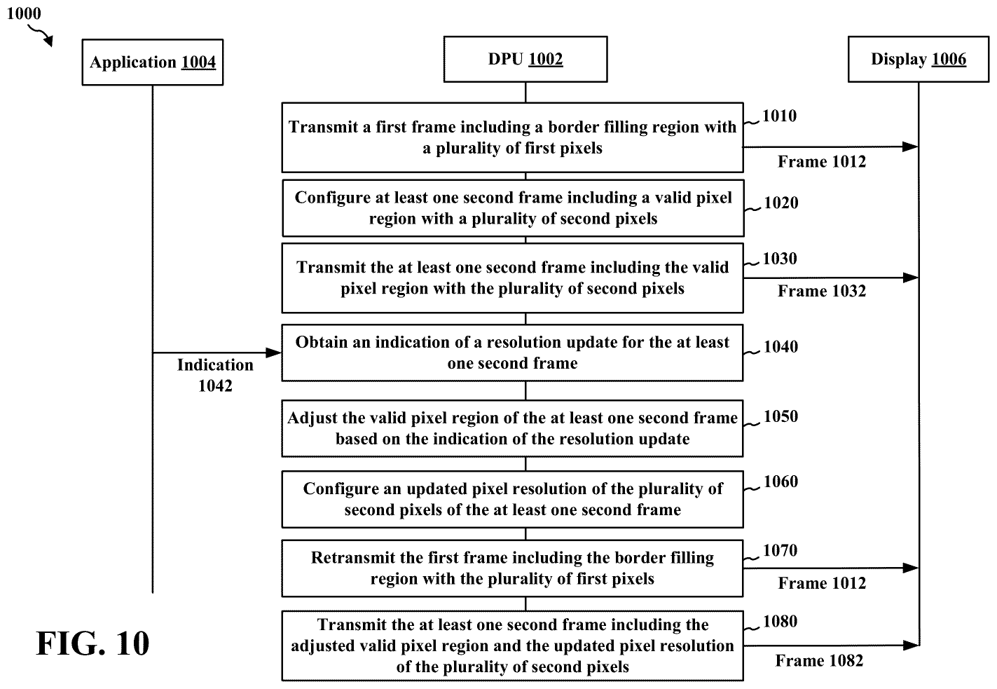

FIG. 10 is a communication flow diagram 1000 of display processing in accordance with one or more techniques of this disclosure. As shown in FIG. 10, diagram 1000 includes example communications between DPU 1002 (or other display processor), application 1004 (e.g., a game or an operating system), and display 1006 (e.g., a display panel), in accordance with one or more techniques of this disclosure.

At 1010, DPU 1002 may transmit, to a display panel, a first frame including a border filling region with a plurality of first pixels (e.g., DPU 1002 may transmit frame 1012 to display 1006), where each of the plurality of first pixels includes a border filling color. The border filling region may include a set of coordinates within the first frame, and the border filling region may include a border pixel resolution. The border filling color may be associated with a pixel format including at least one of: a red (R) green (G) blue (B) (RGB) format or a physical subpixel format. Also, the border filling color may correspond to a color of a physical border for the display panel, where the physical border is associated with an exterior of the display panel. In some aspects, the border filling color may be at least one of the following colors: black, gray, blue, brown, green, or red.

At 1020, DPU 1002 may configure at least one second frame including a valid pixel region with a plurality of second pixels, where the at least one second frame includes second content data and a second pixel resolution. In some aspects, configuring the at least one second frame including the valid pixel region with the plurality of second pixels may include: configuring the at least one second frame including the valid pixel region with the plurality of second pixels at a display processing unit (DPU). That is, the DPU may configure the at least one second frame at a DPU.

At 1030, DPU 1002 may transmit, to the display panel, the at least one second frame including the valid pixel region with the plurality of second pixels (e.g., DPU 1002 may transmit frame 1032 to display 1006). The plurality of second pixels in the valid pixel region of the at least one second frame may correspond to the second content data and the second pixel resolution of the at least one second frame.

At 1040, DPU 1002 may obtain an indication of a resolution update for the at least one second frame (e.g., DPU 1002 may receive indication 1042 from application 1004). In some aspects, obtaining the indication of the resolution update for the at least one second frame may include: receiving the indication of the resolution update from at least one of: at least one application, at least one end user, or an operating system. That is, the DPU may receive the indication of the resolution update from at least one of: at least one application, at least one end user, or an operating system. The second pixel resolution may be aligned with a pixel resolution of at least one of: the at least one application, the at least one end user, or the operating system. The at least one application may be associated with at least one user device for the at least one end user, a headset for the at least one end user, or a head mounted device (HMD) for the at least one end user. Also, the at least one application may be at least one operating application for the operating system. Further, the updated pixel resolution of the plurality of second pixels may be aligned with an updated resolution of the at least one application.

At 1050, DPU 1002 may adjust the valid pixel region of the at least one second frame based on the indication of the resolution update. The valid pixel region may include a resolution of the valid pixel region and/or a size of the valid pixel region. Also, adjusting the valid pixel region may include adjusting the resolution of the valid pixel region and/or the size of the valid pixel region. That is, the DPU may adjust the resolution of the valid pixel region and/or the size of the valid pixel region.

At 1060, DPU 1002 may configure, after adjusting the valid pixel region of the at least one second frame, an updated pixel resolution of the plurality of second pixels of the at least one second frame based on the indication of the resolution update.

At 1070, DPU 1002 may retransmit, to the display panel, the first frame including the border filling region with the plurality of first pixels (e.g., DPU 1002 may retransmit frame 1012 to display 1006).

At 1080, DPU 1002 may transmit, to the display panel, the at least one second frame including the adjusted valid pixel region and the updated pixel resolution of the plurality of second pixels (e.g., DPU 1002 may transmit frame 1082 to display 1006).

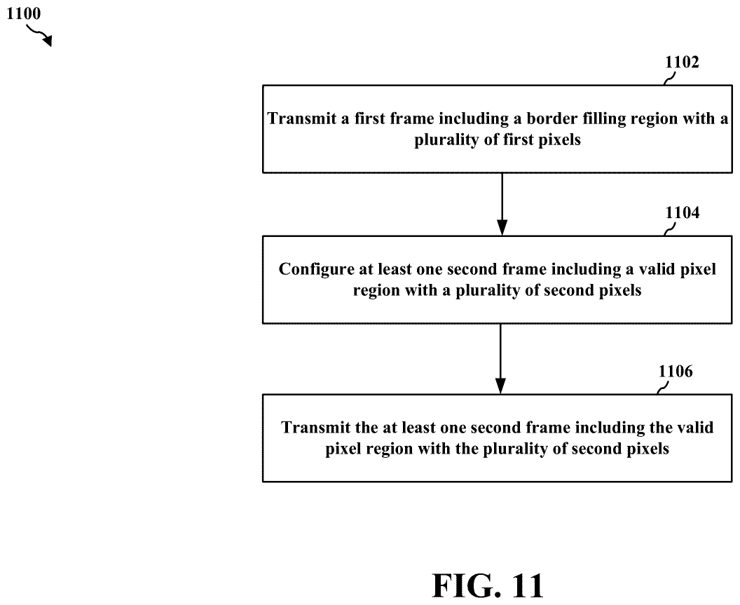

FIG. 11 is a flowchart 1100 of an example method of display processing in accordance with one or more techniques of this disclosure. The method may be performed by a DPU, such as an apparatus for display processing, a display processor, a wireless communication device, and/or any apparatus that may perform display processing as used in connection with the examples of FIGS. 1-10.

At 1102, the DPU may transmit, to a display panel, a first frame including a border filling region with a plurality of first pixels, where each of the plurality of first pixels includes a border filling color, as described in connection with the examples in FIGS. 1-10. For example, as described in 1010 of FIG. 10, DPU 1002 may transmit, to a display panel, a first frame including a border filling region with a plurality of first pixels, where each of the plurality of first pixels includes a border filling color. Further, step 1102 may be performed by display processor 127 in FIG. 1. The border filling region may include a set of coordinates within the first frame, and the border filling region may include a border pixel resolution. The border filling color may be associated with a pixel format including at least one of: a red (R) green (G) blue (B) (RGB) format or a physical subpixel format. Also, the border filling color may correspond to a color of a physical border for the display panel, where the physical border is associated with an exterior of the display panel. In some aspects, the border filling color may be at least one of the following colors: black, gray, blue, brown, green, or red.

At 1104, the DPU may configure at least one second frame including a valid pixel region with a plurality of second pixels, where the at least one second frame includes second content data and a second pixel resolution, as described in connection with the examples in FIGS. 1-10. For example, as described in 1020 of FIG. 10, DPU 1002 may configure at least one second frame including a valid pixel region with a plurality of second pixels, where the at least one second frame includes second content data and a second pixel resolution. Further, step 1104 may be performed by display processor 127 in FIG. 1. In some aspects, configuring the at least one second frame including the valid pixel region with the plurality of second pixels may include: configuring the at least one second frame including the valid pixel region with the plurality of second pixels at a display processing unit (DPU). That is, the DPU may configure the at least one second frame at a DPU.

At 1106, the DPU may transmit, to the display panel, the at least one second frame including the valid pixel region with the plurality of second pixels, as described in connection with the examples in FIGS. 1-10. For example, as described in 1030 of FIG. 10, DPU 1002 may transmit, to the display panel, the at least one second frame including the valid pixel region with the plurality of second pixels. Further, step 1106 may be performed by display processor 127 in FIG. 1. The plurality of second pixels in the valid pixel region of the at least one second frame may correspond to the second content data and the second pixel resolution of the at least one second frame.

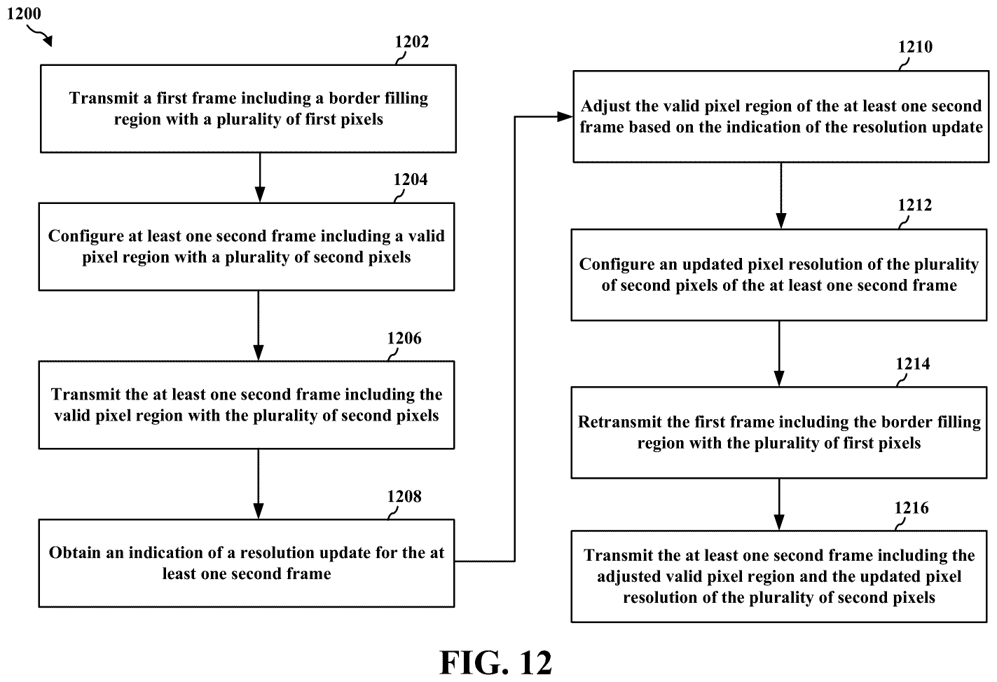

FIG. 12 is a flowchart 1200 of an example method of display processing in accordance with one or more techniques of this disclosure. The method may be performed by a DPU, such as an apparatus for display processing, a display processor, a wireless communication device, and/or any apparatus that may perform display processing as used in connection with the examples of FIGS. 1-10.

At 1202, the DPU may transmit, to a display panel, a first frame including a border filling region with a plurality of first pixels, where each of the plurality of first pixels includes a border filling color, as described in connection with the examples in FIGS. 1-10. For example, as described in 1010 of FIG. 10, DPU 1002 may transmit, to a display panel, a first frame including a border filling region with a plurality of first pixels, where each of the plurality of first pixels includes a border filling color. Further, step 1202 may be performed by display processor 127 in FIG. 1. The border filling region may include a set of coordinates within the first frame, and the border filling region may include a border pixel resolution. The border filling color may be associated with a pixel format including at least one of: a red (R) green (G) blue (B) (RGB) format or a physical subpixel format. Also, the border filling color may correspond to a color of a physical border for the display panel, where the physical border is associated with an exterior of the display panel. In some aspects, the border filling color may be at least one of the following colors: black, gray, blue, brown, green, or red.

At 1204, the DPU may configure at least one second frame including a valid pixel region with a plurality of second pixels, where the at least one second frame includes second content data and a second pixel resolution, as described in connection with the examples in FIGS. 1-10. For example, as described in 1020 of FIG. 10, DPU 1002 may configure at least one second frame including a valid pixel region with a plurality of second pixels, where the at least one second frame includes second content data and a second pixel resolution. Further, step 1204 may be performed by display processor 127 in FIG. 1. In some aspects, configuring the at least one second frame including the valid pixel region with the plurality of second pixels may include: configuring the at least one second frame including the valid pixel region with the plurality of second pixels at a display processing unit (DPU). That is, the DPU may configure the at least one second frame at a DPU.

At 1206, the DPU may transmit, to the display panel, the at least one second frame including the valid pixel region with the plurality of second pixels, as described in connection with the examples in FIGS. 1-10. For example, as described in 1030 of FIG. 10, DPU 1002 may transmit, to the display panel, the at least one second frame including the valid pixel region with the plurality of second pixels. Further, step 1206 may be performed by display processor 127 in FIG. 1. The plurality of second pixels in the valid pixel region of the at least one second frame may correspond to the second content data and the second pixel resolution of the at least one second frame.

At 1208, the DPU may obtain an indication of a resolution update for the at least one second frame, as described in connection with the examples in FIGS. 1-10. For example, as described in 1040 of FIG. 10, DPU 1002 may obtain an indication of a resolution update for the at least one second frame. Further, step 1208 may be performed by display processor 127 in FIG. 1. In some aspects, obtaining the indication of the resolution update for the at least one second frame may include: receiving the indication of the resolution update from at least one of: at least one application, at least one end user, or an operating system. That is, the DPU may receive the indication of the resolution update from at least one of: at least one application, at least one end user, or an operating system. The second pixel resolution may be aligned with a pixel resolution of at least one of: the at least one application, the at least one end user, or the operating system. The at least one application may be associated with at least one user device for the at least one end user, a headset for the at least one end user, or a head mounted device (HMD) for the at least one end user. Also, the at least one application may be at least one operating application for the operating system. Further, the updated pixel resolution of the plurality of second pixels may be aligned with an updated resolution of the at least one application.

At 1210, the DPU may adjust the valid pixel region of the at least one second frame based on the indication of the resolution update, as described in connection with the examples in FIGS. 1-10. For example, as described in 1050 of FIG. 10, DPU 1002 may adjust the valid pixel region of the at least one second frame based on the indication of the resolution update. Further, step 1210 may be performed by display processor 127 in FIG. 1. The valid pixel region may include a resolution of the valid pixel region and/or a size of the valid pixel region. Also, adjusting the valid pixel region may include adjusting the resolution of the valid pixel region and/or the size of the valid pixel region. That is, the DPU may adjust the resolution of the valid pixel region and/or the size of the valid pixel region.

At 1212, the DPU may configure, after adjusting the valid pixel region of the at least one second frame, an updated pixel resolution of the plurality of second pixels of the at least one second frame based on the indication of the resolution update, as described in connection with the examples in FIGS. 1-10. For example, as described in 1060 of FIG. 10, DPU 1002 may configure, after adjusting the valid pixel region of the at least one second frame, an updated pixel resolution of the plurality of second pixels of the at least one second frame based on the indication of the resolution update. Further, step 1212 may be performed by display processor 127 in FIG. 1.

At 1214, the DPU may retransmit, to the display panel, the first frame including the border filling region with the plurality of first pixels, as described in connection with the examples in FIGS. 1-10. For example, as described in 1070 of FIG. 10, DPU 1002 may retransmit, to the display panel, the first frame including the border filling region with the plurality of first pixels. Further, step 1214 may be performed by display processor 127 in FIG. 1.

At 1216, the DPU may transmit, to the display panel, the at least one second frame including the adjusted valid pixel region and the updated pixel resolution of the plurality of second pixels, as described in connection with the examples in FIGS. 1-10. For example, as described in 1080 of FIG. 10, DPU 1002 may transmit, to the display panel, the at least one second frame including the adjusted valid pixel region and the updated pixel resolution of the plurality of second pixels. Further, step 1216 may be performed by display processor 127 in FIG. 1.

In configurations, a method or an apparatus for display processing is provided. The apparatus may be a DPU, a display processor, or some other processor that may perform display processing. In aspects, the apparatus may be the display processor 127 within the device 104, or may be some other hardware within the device 104 or another device. The apparatus, e.g., display processor 127, may include means for transmitting, to a display panel, a first frame including a border filling region with a plurality of first pixels, where each of the plurality of first pixels includes a border filling color. The apparatus, e.g., display processor 127, may also include means for configuring at least one second frame including a valid pixel region with a plurality of second pixels, where the at least one second frame includes second content data and a second pixel resolution. The apparatus, e.g., display processor 127, may also include means for transmitting, to the display panel, the at least one second frame including the valid pixel region with the plurality of second pixels. The apparatus, e.g., display processor 127, may also include means for obtaining an indication of a resolution update for the at least one second frame. The apparatus, e.g., display processor 127, may also include means for adjusting the valid pixel region of the at least one second frame based on the indication of the resolution update. The apparatus, e.g., display processor 127, may also include means for configuring, after adjusting the valid pixel region of the at least one second frame, an updated pixel resolution of the plurality of second pixels of the at least one second frame based on the indication of the resolution update. The apparatus, e.g., display processor 127, may also include means for retransmitting, to the display panel, the first frame including the border filling region with the plurality of first pixels. The apparatus, e.g., display processor 127, may also include means for transmitting, to the display panel, the at least one second frame including the adjusted valid pixel region and the updated pixel resolution of the plurality of second pixels.

The subject matter described herein may be implemented to realize one or more benefits or advantages. For instance, the described display processing techniques may be used by a DPU, a display processor, or some other processor that may perform display processing to implement the sequential flexible display resolution techniques described herein. This may also be accomplished at a low cost compared to other display processing techniques. Moreover, the display processing techniques herein may improve or speed up data processing or execution. Further, the display processing techniques herein may improve resource or data utilization and/or resource efficiency. Additionally, aspects of the present disclosure may utilize sequential flexible display resolution techniques in order to improve memory bandwidth efficiency and/or increase processing speed at a DPU.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for display processing including at least one processor coupled to a memory and, based at least in part on first information stored in the memory, the at least one processor is configured to: transmit, to a display panel, a first frame including a border filling region with a plurality of first pixels, where each of the plurality of first pixels includes a border filling color; configure at least one second frame including a valid pixel region with a plurality of second pixels, where the at least one second frame includes second content data and a second pixel resolution; and transmit, to the display panel, the at least one second frame including the valid pixel region with the plurality of second pixels.

Aspect 2 is the apparatus of aspect 1, where the at least one processor is further configured to: obtain an indication of a resolution update for the at least one second frame; and adjust the valid pixel region of the at least one second frame based on the indication of the resolution update.

Aspect 3 is the apparatus of aspect 2, where the at least one processor is further configured to: configure, after being configured to adjust the valid pixel region of the at least one second frame, an updated pixel resolution of the plurality of second pixels of the at least one second frame based on the indication of the resolution update.

Aspect 4 is the apparatus of aspect 3, where the at least one processor is further configured to: retransmit, to the display panel, the first frame including the border filling region with the plurality of first pixels.

Aspect 5 is the apparatus of aspect 4, where the at least one processor is further configured to: transmit, to the display panel, the at least one second frame including the adjusted valid pixel region and the updated pixel resolution of the plurality of second pixels.

Aspect 6 is the apparatus of any of aspects 2 to 5, where to obtain the indication of the resolution update for the at least one second frame, the at least one processor is configured to: receive the indication of the resolution update from at least one of: at least one application, at least one end user, or an operating system.

Aspect 7 is the apparatus of aspect 6, where the second pixel resolution is configured to be aligned with a pixel resolution of at least one of: the at least one application, the at least one end user, or the operating system.

Aspect 8 is the apparatus of any of aspects 6 to 7, where the at least one application is associated with at least one user device for the at least one end user, a headset for the at least one end user, or a head mounted device (HMD) for the at least one end user, and where to adjust the valid pixel region of the at least one second frame, the at least one processor is configured to: adjust at least one of a resolution of the valid pixel region or a size of the valid pixel region.

Aspect 9 is the apparatus of any of aspects 6 to 8, where the updated pixel resolution of the plurality of second pixels is configured to be aligned with an updated resolution of the at least one application.

Aspect 10 is the apparatus of any of aspects 1 to 9, where the border filling region includes a set of coordinates within the first frame, and where the border filling region includes a border pixel resolution.

Aspect 11 is the apparatus of any of aspects 1 to 10, where the border filling color is associated with a pixel format including at least one of: a red (R) green (G) blue (B) (RGB) format or a physical subpixel format.

Aspect 12 is the apparatus of any of aspects 1 to 11, where the plurality of second pixels in the valid pixel region of the at least one second frame corresponds to the second content data and the second pixel resolution of the at least one second frame.

Aspect 13 is the apparatus of any of aspects 1 to 12, where the border filling color corresponds to a color of a physical border for the display panel, and where the physical border is associated with an exterior of the display panel.

Aspect 14 is the apparatus of any of aspects 1 to 13, where to configure the at least one second frame including the valid pixel region with the plurality of second pixels, the at least one processor is configured to: configure the at least one second frame at a display processing unit (DPU).

Aspect 15 is the apparatus of any of aspects 1 to 14, further including at least one of an antenna or a transceiver coupled to the at least one processor, where to transmit the first frame, the at least one processor is configured to transmit the first frame via at least one of the antenna or the transceiver.

Aspect 16 is a method of display processing for implementing any of aspects 1 to 15.

Aspect 17 is an apparatus for display processing including means for implementing any of aspects 1 to 15.

Aspect 18 is a computer-readable medium (e.g., a non-transitory computer-readable medium) storing computer executable code, the code when executed by at least one processor causes the at least one processor to implement any of aspects 1 to 15.

What is claimed is:

1. An apparatus for display processing, comprising:
a memory; and
at least one processor coupled to the memory, based at least in part on first information stored in the memory, the at least one processor is and configured to:
transmit, to a display panel, a first frame including a border filling region with a plurality of first pixels, wherein each of the plurality of first pixels includes a border filling color;
configure at least one second frame including a valid pixel region with a plurality of second pixels, wherein the at least one second frame includes second content data and a second pixel resolution; and
transmit, to the display panel, the at least one second frame including the valid pixel region with the plurality of second pixels.

2. The apparatus of claim 1, wherein the at least one processor is further configured to:
obtain an indication of a resolution update for the at least one second frame; and
adjust the valid pixel region of the at least one second frame based on the indication of the resolution update.

3. The apparatus of claim 2, wherein the at least one processor is further configured to:
configure, after being configured to adjust the valid pixel region of the at least one second frame, an updated pixel resolution of the plurality of second pixels of the at least one second frame based on the indication of the resolution update.

4. The apparatus of claim 3, wherein the at least one processor is further configured to:
retransmit, to the display panel, the first frame including the border filling region with the plurality of first pixels.

5. The apparatus of claim 4, wherein the at least one processor is further configured to:
transmit, to the display panel, the at least one second frame including the adjusted valid pixel region and the updated pixel resolution of the plurality of second pixels.

6. The apparatus of claim 3, wherein to obtain the indication of the resolution update for the at least one second frame, the at least one processor is configured to: receive the indication of the resolution update from at least one of: at least one application, at least one end user, or an operating system.

7. The apparatus of claim 6, wherein the second pixel resolution is configured to be aligned with a pixel resolution of at least one of: the at least one application, the at least one end user, or the operating system.

8. The apparatus of claim 6, wherein the at least one application is associated with at least one user device for the at least one end user, and wherein to adjust the valid pixel region of the at least one second frame, the at least one processor is configured to: adjust at least one of a resolution of the valid pixel region and a size of the valid pixel region.

9. The apparatus of claim 6, wherein the updated pixel resolution of the plurality of second pixels is configured to be aligned with an updated resolution of the at least one application.

10. The apparatus of claim 1, wherein the border filling region includes a set of coordinates within the first frame, and wherein the border filling region includes a border pixel resolution.

11. The apparatus of claim 1, wherein the border filling color is associated with a pixel format including at least one of: a red (R) green (G) blue (B) (RGB) format or a physical subpixel format.

12. The apparatus of claim 1, wherein the plurality of second pixels in the valid pixel region of the at least one second frame corresponds to the second content data and the second pixel resolution of the at least one second frame.

13. The apparatus of claim 1, wherein the border filling color corresponds to a color of a physical border for the display panel, and wherein the physical border is associated with an exterior of the display panel.

14. The apparatus of claim 1, wherein to configure the at least one second frame including the valid pixel region with the plurality of second pixels, the at least one processor is configured to: configure the at least one second frame at a display processing unit (DPU).

15. The apparatus of claim 1, further comprising at least one transceiver coupled to the at least one processor, wherein to transmit the first frame, the at least one processor is configured to transmit the first frame via the at least one transceiver.

16. A method of display processing, comprising:
transmitting, to a display panel, a first frame including a border filling region with a plurality of first pixels, wherein each of the plurality of first pixels includes a border filling color;
configuring at least one second frame including a valid pixel region with a plurality of second pixels, wherein the at least one second frame includes second content data and a second pixel resolution; and
transmitting, to the display panel, the at least one second frame including the valid pixel region with the plurality of second pixels.

17. The method of claim 16, further comprising:
obtaining an indication of a resolution update for the at least one second frame; and
adjusting the valid pixel region of the at least one second frame based on the indication of the resolution update.

18. The method of claim 17, further comprising:
configuring, after adjusting the valid pixel region of the at least one second frame, an updated pixel resolution of the plurality of second pixels of the at least one second frame based on the indication of the resolution update.

19. The method of claim 18, further comprising:
retransmitting, to the display panel, the first frame including the border filling region with the plurality of first pixels.

20. The method of claim 19, further comprising:
transmitting, to the display panel, the at least one second frame including the adjusted valid pixel region and the updated pixel resolution of the plurality of second pixels.

21. The method of claim 18, wherein obtaining the indication of the resolution update for the at least one second frame comprises: receiving the indication of the resolution update from at least one of: at least one application, at least one end user, or an operating system.

22. The method of claim 21, wherein the second pixel resolution is aligned with a pixel resolution of at least one of: the at least one application, the at least one end user, or the operating system.

23. The method of claim 21, wherein the at least one application is associated with at least one user device for the at least one end user, and wherein adjusting the valid pixel region of the at least one second frame comprises: adjusting at least one of a resolution of the valid pixel region and a size of the valid pixel region.

24. The method of claim 21, wherein the updated pixel resolution of the plurality of second pixels is aligned with an updated resolution of the at least one application.

25. The method of claim 16, wherein the border filling region includes a set of coordinates within the first frame, and wherein the border filling region includes a border pixel resolution.

26. The method of claim 16, wherein the border filling color is associated with a pixel format including at least one of: a red (R) green (G) blue (B) (RGB) format or a physical subpixel format.

27. The method of claim 16, wherein the plurality of second pixels in the valid pixel region of the at least one second frame corresponds to the second content data and the second pixel resolution of the at least one second frame, and wherein configuring the at least one second frame including the valid pixel region with the plurality of second pixels comprises: configuring the at least one second frame at a display processing unit (DPU).

28. The method of claim 16, wherein the border filling color corresponds to a color of a physical border for the display panel, and wherein the physical border is associated with an exterior of the display panel.

29. An apparatus for display processing, comprising:
means for transmitting, to a display panel, a first frame including a border filling region with a plurality of first pixels, wherein each of the plurality of first pixels includes a border filling color;
means for configuring at least one second frame including a valid pixel region with a plurality of second pixels, wherein the at least one second frame includes second content data and a second pixel resolution; and
means for transmitting, to the display panel, the at least one second frame including the valid pixel region with the plurality of second pixels.

30. A computer-readable medium storing computer executable code for display processing, the code when executed by a processor causes the processor to:
transmit, to a display panel, a first frame including a border filling region with a plurality of first pixels, wherein each of the plurality of first pixels includes a border filling color;
configure at least one second frame including a valid pixel region with a plurality of second pixels, wherein the at least one second frame includes second content data and a second pixel resolution; and
transmit, to the display panel, the at least one second frame including the valid pixel region with the plurality of second pixels.
